(19) United States
(12) Patent Application Publication
(10) Pub. No.: US 2011/0313550 A1
(43) Pub. Date: Dec. 22, 2011

(54) SELECTION SYSTEM FOR GAMING

(76) Inventor: Yaniv Altshuler, Ramat Ishai (IL)

(21) Appl. No.: 12/922,176

(22) PCT Filed: Mar. 9, 2009
(86) PCT No.: PCT/IL09/00258

§ 371 Date: Mar. 2, 2011

(30) Foreign Application Priority Data
Mar. 11, 2008 (IL) 190111

(51) Int. Cl. G06F 19/00

(52) U.S. Cl. 700/91

(57) ABSTRACT

A system and method in which one or more components from a game may be selected and then automatically detected during game play. The components may optionally be detected automatically according to one or more predefined criteria. Alternatively, the components may optionally be detected through analysis of saved game playing data, such that optionally and more preferably, the extraction process may be performed according to one or more criteria that are set after game play has occurred.

### FIELD OF THE INVENTION

The present invention relates to a selection system for gaming and in particular, for a system and method for supporting selection of particular components and/or actions within a game.

### BACKGROUND OF THE INVENTION

Modern games consume many processing and storage resources, mainly since the games usually involve progressive 3D (three dimensions) computer graphics and sound effects. A game exists in a computerized world, which comprises various graphical objects. Every object is attributed to a game element, i.e., background, articles, characters etc. Each object is accompanied by a corresponding logic, which defines the operations the object can perform and the rules of actions upon the occurrence of any event.

A simplified example of a game world in car racing game is as follows: The game world comprises objects, such as racetrack, racing cars, sky, observers, etc. The racetrack, the sky and the observers are used as background elements, where the logic of the sky objects can be defined to change according to the weather; the observers can be defined to applaud whenever a specific car is passing, and so on. One car is controlled by the game player and the rest of the cars are automatically controlled by the computer. The logic of the player's car defines the movement options (left, right, accelerate, decelerate) and the rules of actions upon events. For example, a collision between the player's car and another object causes the graphical representation of the car to change, and will also typically induce some other change in the game experience, for example by altering the performance of the car and/or loss of credits in the game. Exceeding the racetrack boundaries will slow down the car, and so on. Some of the computer controlled cars are defined to drive at a certain speed, and some are defined to follow the player's car. Objects can also be defined to perform no action.

Creating a 3D Image of a Game

Every graphical object in the game world has physical 3D dimensions, texture and opacity/transparency, and is located and/or moved in the game space. A 3D computer graphics video can be considered as a movie production. Like in a filming location, the game objects always exist in the game space, even if the objects are not shown all the time. After all the objects are located in the game space, in order to get video images, a camera is located in a certain point. The camera can be located at any point in the game space at any angle, and can move in any direction and at any desired speed. The camera will project the images (on the computer's screen) according to graphical definitions and the locations of the objects in the game space.

### SUMMARY OF THE INVENTION

The background art does not teach or suggest a selection system which provides a visual language for description and/or analysis of game data.

The background art does not teach or suggest a selection system for gaming which enables one or more components of the game to be selected for constructing a visual language for description and/or analysis of game play data.

The present invention overcomes these drawbacks of the background art by providing, in at least some embodiments, a system and method for a visual tool for generating semantic queries, which are then preferably automatically translated into queries in a pre-defined language, for extracting and/or detecting one or more components from a collection of data. Preferably, the system and method are operative for analysis of games as defined herein. The components may optionally comprise one or more of details, knowledge, or data. The components may optionally be detected automatically according to one or more predefined criteria. Alternatively, the components may optionally be detected through analysis of data, such as saved game playing data, such that optionally and more preferably, the extraction process may be performed according to one or more criteria that are set after game play has occurred.

By “game” or “gaming” it is optionally meant any type of game in which at least a portion of the game play and/or at least one game action occurs electronically, through a computer or any type of game playing device, as described in greater detail below. Such games include but are not limited to games, computer games, on-line games, multi-player on-line games, persistent on-line or other computer games, games featuring short matches, single player games, automatic player games or games featuring at least one “bot” as a player, anonymous matches, simulation software which involves a visual display, monitoring and control systems that involve a visual display, arcade machines, video games, console games, software related to the operation of casinos or games of chance and the like.

By “component” it is meant any element of data and more preferably of a game, which may optionally comprise one or more of an object, a character, an action, an interaction between any of the preceding or a combination thereof.

It should be noted that although the present invention is described herein with regard to gaming, this is for the purpose of illustration only and is not meant to be limiting in any way. Optionally, the present invention (in some embodiments) may also be used for the analysis of non-gaming data collections, optionally including data which does not feature one or more visual components, for example with regard to any simple or integrated system in which a large amount of (complex) data is available, in which valuable information is hidden within the larger collection of data, for example including but not limited to, financial systems and payment systems (such as the cash register system as provided by Retalix, IBM and others, for example). For example, an embodiment of the present invention can be used by a register system for analyzing customer behavior for providing statistical information or information about changes in the consumer habits or for scoring the customer and the like. According to another embodiment, the method of the present invention is optionally used to analyze audio data.

The selection process preferably includes the definition of one or more components of interest to be detected during game play (or during analysis of data obtained after game play). The components may optionally comprise generic stock characters, objects and/or actions. By “generic” it is meant that the components are not specific to a particular game, but may optionally instead be related to all games, or alternatively to all games of a particular type or genre. The components may also optionally comprise one or more specific characters and actions for a game, for example from the game designer, which may then be optionally added manually or automatically to the selection system.

In addition to selecting particular components, in some embodiments the present invention also features connecting such components with one or more symbols and/or connectors to construct scene instances. For example, the scene instance could optionally require the presence of three characters, two of which interact through a particular action, followed by an interaction with the third character through another action. One or more connectors may optionally be temporal.

Regardless of whether one or more components or one or more scene instances are selected, preferably a file or datastream is then generated for storing the queries that are generated from the selecting of one or more objects. The file includes generated commands for a script. The file or datastream may optionally be generated locally (to the user) or at a remote server. The game play data may optionally be provided in the form of complete game data. Additionally or alternatively, the complete game data may optionally be analyzed to provide one or more “clips” or highlights; such clips may optionally be provided as the output of the selection system. The clips are preferably obtained as described in the corresponding U.S. Provisional Application No. 61/136,064 entitled “TECHNOLOGICAL PLATFORM FOR GAMING”, filed on the same day as the present application (Aug. 11, 2008) and with the same owner and at least one inventor in common, which is hereby incorporated by reference as if fully set forth herein. However, it should be noted that optionally any type of highlights and/or system and method for obtaining such highlights may be used.

According to one embodiment of the present invention, analyzing the data may then optionally result in the performance of one or more actions. For example, analyzing the bad behavior of a certain player in a game may result in the player being blocked from further play; or, analyzing a behavior of a certain customer may cause different offers to be made this customer, depending upon the results of the analysis.

According to another embodiment of the present invention, the visual tool for generating semantic queries can be used for the creation of “movies” (a stream of video data comprising a plurality of scene instances) or, at least one or more scenes instances, in addition to analyzing the data from which such scene instances are constructed.

PCT application 2008/004236 filed on Jul. 5, 2007 teaches a method for automatic generation video from structured content comprising a unit for defining functions for applying playable effects to objects a time unit for adding time boundaries to said function, an ordering unit and a translation unit and a method for rendering a playable sequence. However, this application differs from the present invention in that it does not feature a visual language for constructing a scene analysis, nor does it permit analysis of scene instances from game play data, for example from computer games. This application is hereby incorporated by reference as if fully set forth herein.

By “online”, it is meant that communication is performed through an electronic and/or optic communication medium, including but not limited to, telephone data communication through the PSTN (public switched telephone network), cellular telephones, IP network, ATM (asynchronous transfer mode) network, frame relay network, MPLS (Multi Protocol Label Switching) network, any type of packet switched network, or the like network, or a combination thereof; data communication through cellular telephones or other wireless or RF (radiofrequency) devices; any type of mobile or static wireless communication; exchanging information through Web pages according to HTTP (HyperText Transfer Protocol) or any other protocol for communication with and through mark-up language documents or any other communication protocol, including but not limited to IP, TCP/IP, UDP and the like; exchanging messages through e-mail (electronic mail), instant messaging services such as ICQ™ for example, and any other type of messaging service or message exchange service; any type of communication using a computer as defined below; as well as any other type of communication which incorporates an electronic and/or optical medium for transmission. The present invention can be implemented both on the internet and the intranet, as well as on any type of computer network. However, it should be noted that the present invention is not limited to on-line games or software or systems; furthermore, optionally the selection process data is generated locally to the user and/or at a remote server.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and memory storage, and/or the ability to execute one or more instructions may be described as a computer, including but not limited to a PC (personal computer), a server, a minicomputer, a cellular telephone, a smart phone, a PDA (personal data assistant), a pager, TV decoder, VOD (video on demand) recorder, game console, hand-held game consoles or other dedicated gaming device, digital music or other digital media player, ATM (machine for dispensing cash), POS credit card terminal (point of sale), electronic cash register, or ultra mobile personal computer, arcade machines, or a combination thereof. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 shows a schematic block diagram of an exemplary, illustrative non-limiting embodiment of a selection system according to the present invention;

FIG. 2 is a flowchart of an exemplary, illustrative method for selecting one or more components;

FIG. 3 illustrates an exemplary Query Language;

FIG. 4 provides a non-limiting description of the query components and their order;

FIG. 5 is a flowchart of an exemplary method for translating the query directives into a movie, through the capture of the desired data from actual game play in this non-limiting example, according to at least some embodiments of the present invention;

FIGS. 6-8 relate to exemplary, non-limiting screenshots of the visual scripting tool; and

FIG. 9 shows an exemplary complete script for executing a query to create a movie according to the following situation, for “The Avenger”.

### DETAILED DESCRIPTION OF PREFERRED EMBODIMENTS

The present invention, in at least some embodiments, is of a system and method in which one or more components from a game may be selected and then automatically detected during game play (and/or in data obtained after game play). The components may optionally be detected automatically according to one or more predefined criteria. Alternatively, the components may optionally be detected through analysis of saved game playing data, such that optionally and more preferably, the extraction process may be performed according to one or more criteria that are set after game play has occurred.

The selection system is preferably operative “outside of the game”, in the sense that it does not necessarily require access to game code and/or does not require direct interactions with the game software, although such access and/or interactions may optionally be provided in some embodiments.

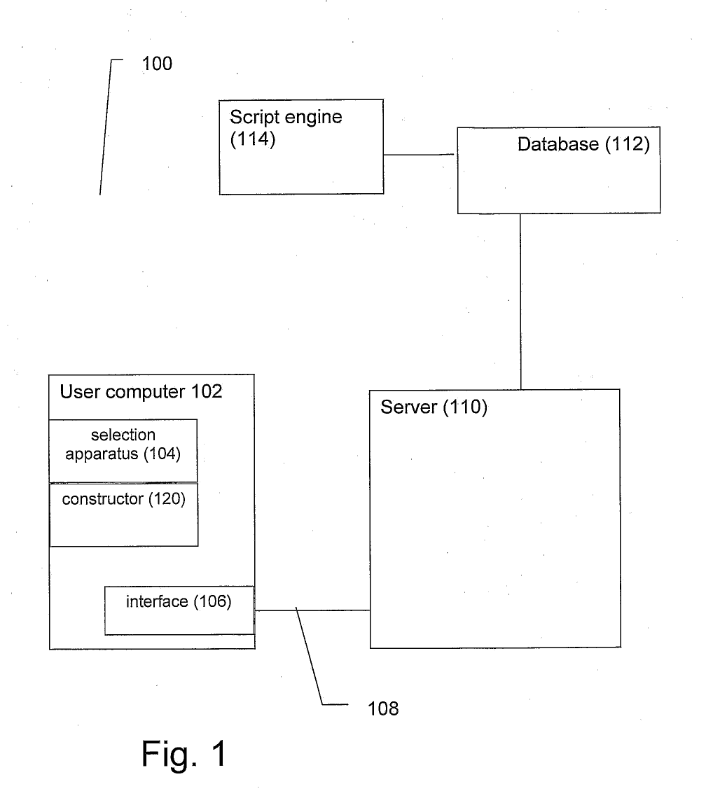

Turning now to the drawings, FIG. 1 shows a schematic block diagram of an exemplary, illustrative non-limiting embodiment of a selection system according to the present invention.

As shown, a system 100 features a user computer 102, which is operated by the person who is selecting one or more components (not shown). User computer 102 operates a selection apparatus 104 for selecting the one or more components, and optionally and preferably for constructing one or more scenes with a constructor 120 as described in greater detail below. Selection apparatus 104 preferably provides a GUI (graphical user interface) with a plurality of characters, actions and objects. The user is able to select one or more of these components, which are preferably graphically represented.

The user is more preferably able to then indicate a connection between one or more such components according to one or more interactions, for example by determining that a character performs an action on an object. One or more connectors may optionally be temporal in nature. Optionally, additionally one or more connectors may be logic connectors and/or genre specific connectors and/or game specific connectors, or any type of logics and so forth. Such a combination is referred to herein as an instance of a scene. Most preferably, the connections between the components are made graphically, for example by drawing a line. The actually connection between the components is then preferably performed by constructor 120. Most preferably, the user interactions are made through selection apparatus 104 as the user interface, while constructor 120 preferably performs one or more actions according to one or more user commands received through selection apparatus 104.

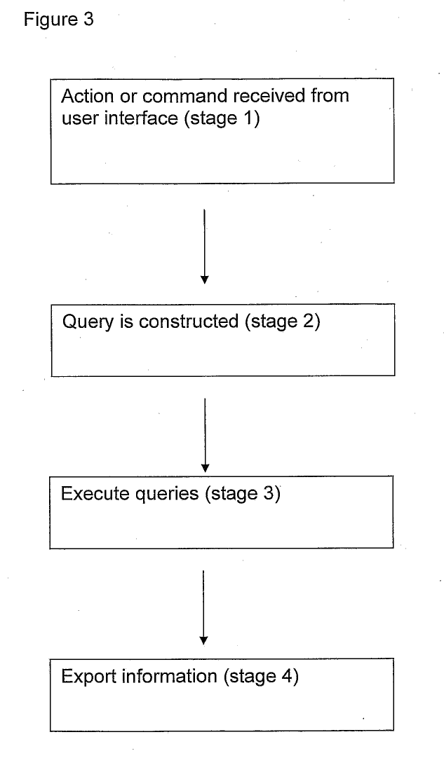

Selection apparatus 104 optionally and preferably provides a visual language for event analysis in a game to the user, through a user interface, as described herein. This visual language is preferably a temporal, semantic language that uses visual building blocks which are then connected according to a sequence of interaction(s) to form scenes, according to some embodiments as described herein. Selection apparatus 104 therefore provides a visual tool for selecting one or more components for later detection and/or for receiving one or more user commands constructing one or more scenes, although as noted above the construction process is preferably performed through constructor 120. The selecting of one or more components and/or the provision of one or more commands for constructing one or more scenes is preferably automatically translated into a query language. Such an exemplary query language is described in greater detail with regard to FIG. 3 below.

Once the user has determined that a scene, or even a single component or plurality of components, is of interest for detection in actual game play data, an interface 106 preferably packages the scene and/or single component and/or plurality of components into a file comprising the written query language of the scripts, as received from constructor 120. The file preferably contains one or more scripts, more preferably written in the Generic Games Representation Language (GGRL), described in greater detail below. Therefore, interface 106 preferably acts as an interpreter, for rendering the graphically selected information, and the received information regarding one or more connections between such selected information, into one or more scripts.

The scripts are then preferably provided to a server 110 through a network 108, which may for example optionally be any type of computer network as described herein, such as the Internet. Alternatively, the functions of interface 106 may optionally be provided on server 110. The scripts are preferably stored in a database 112 until they are ready for use. Server 110 may also optionally analyze the game play data obtained during execution of game play. Alternatively or additionally, a script engine 114 may optionally run the one or more scripts in database 112 to analyze the game play data. The game play data may optionally be analyzed in real time or alternatively may be analyzed after play, both of which are described in greater detail in the corresponding U.S. Provisional Application No US 61/136,064 entitled “TECHNOLOGICAL PLATFORM FOR GAMING”, as previously described.

According to some optional embodiments, the present invention optionally features the Generic Games Representation Language (GGRL), which is a special generic representation language into which data generated by any game engine may be translated. According to some embodiments of the present invention, after the original game data is translated to the GGRL, the generic data is analyzed, rather than analyzing the original game data itself. Every game has its own language, which comprises various data types that can be categorized into several pre-defined lexical categories, such as background elements, actions of movements, articles, etc. During the translation process, each data type is mapped into one or more data elements in the GGRL. The GGRL elements are accompanied with indexing, symbolizing a specific element, the dominance/strength of an element or the functionality of an object.

The GGRL comprises data elements as follows:

Background—background view, elements rendered by the game engine to foliage, landscape, etc.

Objects—the main elements in the game, in terms of importance, symbolizes other players, monsters, etc’. Objects can sustain positive of negative effects, and usually possess the ability to manipulate the gaming world.

AutoObjects—There are game engines where the raw data distinguishes between human (player) controlled objects and automatic controlled objects. The second type will be translated to AutoObjects.

Subjects—used for objects which do not have any effect on the players, but can be manipulated by them (e.g. doors, chairs, articles that can be picked or moved, etc.).

PosActuator—object which have a positive influence over a player (e.g. treasure chests, medical kits, bonus elements, etc).

NegActuator—object which have a negative influence over a player (e.g. flying bullets, poison, etc).

PosAction—an action on an object, which bears a positive effect (usually involving a positive actuator), for example—a player picking a medical kit and getting his health enhanced.

NegAction—an action on an object, which bears a negative effect (usually involving a negative actuator), for example—a player getting hit by a bullet.

Event—an event that occurs in a game that is not otherwise covered by a PosAction or a NegAction.

GameSpecific—a unique object/action/actuator of a specific game. Each game may have its own GameSpecific objects added to the GGRL. Although this definition is game specific, it becomes an integral part of the generic game-independent infrastructure, and thus does not require any special treatment on the GGRL.

Strings of sequences of GGRL elements are formed in order to describe actions of the game. For example, a knife lying on the ground may be translated to the sequence {Subject(2), NegActuator(7), GameSpecific(2)}. The first element represents the knife being a subject that can be picked up or moved; the second element represents the knife's ability to inflict wounds to other characters; the third element represents the knife being a stabbing weapon (assuming that a category of the various stabbing weapons of the game was defined). In this example, a single data object of a game, i.e. knife, is translated into three elements.

During the operation of the game's engine, the game engine produces streams of game data objects, which are optionally captured by the system of the invention for analysis. Optionally also meta data, such as the name of a player, rank of the player, date/time and so forth is provided. Then the data is translated into the GGRL. The GGRL enables the system of the invention to perform analyses and manipulations on the generic data, preferably by using the query language. In addition, by constructing the one or more scripts for detecting one or more components and/or scenes in GGRL, detection of such components and/or scenes is greatly simplified. It should also be noted that the GGRL can also be used for describing any other form of data, such as for example data regarding consuming habits. In the case an object can be, for example a consumer. PosActuator can be, for example, a coupon, a reduction in price and the like.

However, it should be noted that the above list and indeed the example of GGRL itself is intended for illustrative purposes only and is not meant to be limiting in any way. Many other types of languages may optionally be used, additionally or alternatively.

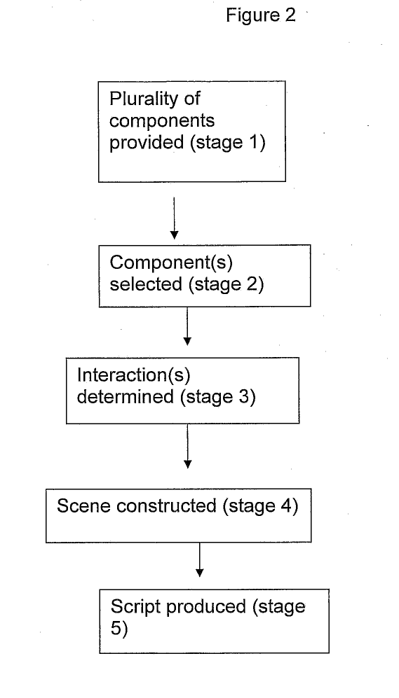

FIG. 2 shows a flowchart of an exemplary selection process according to the present invention. In stage 1, a plurality of components is provided through a user interface, which is preferably a GUI (graphical user interface). The components preferably include a selection of objects (player controlled or otherwise), actions, states, spatial logic connectors and temporal logic connectors, optionally and preferably with one or more qualifiers, for example to indicate an amount or degree of any of the above components, to indicate a contextual relationship between the objects and so forth. As previously described, the components may optionally be generic to any game, and/or to a specific type of game (ball playing game for example); more preferably, at least one game specific component is included. Such a game specific component may optionally be programmed manually for provision to the user through the user interface.

In stage 2, the user selects one or more components through the user interface. Although optionally only one component is selected, for the sake of illustration only and without any intention of being limiting, this exemplary method features the selection of a plurality of components.

In stage 3, the user optionally determines at least one interaction between the components selected. The determination is preferably made graphically through the user interface. For example, if a character is to effect an action on another character or object, a line may optionally be drawn from the first character to the other character or object. The direction of the line may optionally indicate which component is having the effect on which other component. Of course, other symbols may optionally be used, alternatively or additionally.

In stage 4, a plurality of components and at least one interaction is optionally and preferably used to construct a scene. The scene then forms the unit to be detected during analysis of game play data. Alternatively, only the one or more selected components form the unit to be detected during such analysis.

In stage 5, a script which is preferably based on the query language (described in greater detail in FIG. 3 below) is produced which enables the above scene (or one or more components) to be detected in the game play data. The script is preferably written in a language which also is used for analyzing the game play data, or even in which the game play data emerges from execution of the game. A non-limiting example of such a scripting language is GGRL. When there is a requirement to detect the scene, which is defined by the script (for example when the game is being played), the script preferably detects the scene from the GGRL based translation of the game play data, as such a translation provides a generic format for the data description.

FIG. 3 relates to an exemplary description of the query language and of the translation process to the query language. It should be noted that the present invention is not limited to this particular implementation of the query language which is given for the purpose of illustration only. The exemplary query language is preferably used for the defining of game queries. The query is preferably written in an XML-based language and is designed to be used as an intermediary between a higher-level graphic tool for designing game queries (described in greater detail in FIG. 1 above), and a low-level logic resolver, which is in charge of executing the queries. The query language is designed to be used by non-programming users, who are interested in composing new game queries. The language is preferably designed as a declarative language, rather than a functional language. The language is preferably sufficiently rich for defining all or almost all game queries and is also relatively intuitive and easy to follow. The queries are preferably written as .XML files wherein each file can have one or more queries. The queries can optionally use other queries using the use_macro command, which is described hereinafter. Each query can optionally declare the query version. The description provided hereinafter illustrates an exemplary method for defining the query language. It should be noted that this format is provided as an example only and any other format can be used for defining the query language.

According to the exemplary format, each file is preferably defined by the following format, although it should be noted that optionally one or more elements of such a file may be omitted while still maintaining the inventive concept according to at least some embodiments.

Optionally, the file starts with a declaration which preferably appears only once in the file, as the first tag in the file wherein the syntax of the declaration is: <MQL> at the beginning of the file (the term “MQL” stands for “Memoraze Query Language” tag but otherwise any name could optionally be used).

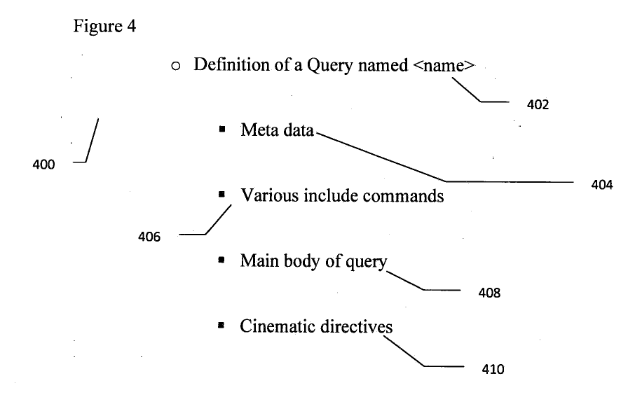

In stage 1, each action or command is received from the user interface, comprising a plurality of components. Optionally a plurality of actions or commands is received simultaneously; however, each query is preferably constructed separately. In stage 2, the query is constructed and is defined within the file. The definition of a new query optionally appears one or more times, depending on the number of queries defined in the file. A description of the query components and their order is provided in FIG. 4, as a non-limiting example only.

The syntax of the query definition of a query 400 in this non-limiting example is <query name=“NAME”> 402 wherein NAME is the name of the query.

Following the name, there is preferably provided a meta data section 404. The definition of the meta data preferably appears once within a query block and comprises various data elements, which are not part of the query itself. The syntax for this definition is <meta> which is a mandatory tag follow by optional tags which are defined inside the <meta> block. The optional tag list for providing various types of meta data preferably includes but is not limited to the following tags: <author>Author</author> wherein the author is the name of author of the query; <date>Date</date> wherein the date is defined as a single number, for example 01122008 defines the first of December 2008; <version>Version</version> wherein the version specifies the language version used for defining the query; <misc>Misc</misc> for defining any information which might be useful for the resolver, which is the entity that later translates the query into one or more commands for data analysis action(s) and also preferably resolves the query itself; creation_date>date</creation_date>, for defining the creation date of the original query (this tag is optional but may be useful in cases where more than one query for performing the same data analysis action or actions is constructed, such that a later version may optionally supersede an earlier version); <update_date>date</update_date> for defining the date of the new version, if this query updates an already existing query (as described above, this is useful where multiple versions of the same query may be provided at different times); <game_type>FPS</game_type> for updating the game type, whether by game manufacturer, game playing device, multi-player vs. single player games and so forth, and/or according to the type of underlying engine powering the game if applicable; and <game_name>CS</game_name> for specifying the game's name.

The “include” commands, shown in an include section 406, are preferably used for including MQL files in queries 400 which are used as macros (ie commands which themselves comprise one or more commands). These commands can optionally appear one or more times in a query block. The syntax for such a command is: <include>filename.extension</include> wherein “filename” optionally includes path to a folder that is different than the current folder. Include section 406 allows complex queries to be rapidly built from reusable queries 400 that were already constructed, thereby reducing the complexity of the translation process.

The main body 408 of query 400 appears only once. The main body 408 is preferably structured as a logic expression tree, comprising a structure for which the start is identified by the <body> tag as the root, followed by one or more levels. At every level there are preferably one or more elements. The value of the <body> is determined by the value of its sons, and by the logic operator binding them. This definition is recursively continued until reaching the tree's leaves. Binding elements within the same level is preferably done using a logic operator and, or, not, xor, out_of, exact_out_of and the like. The syntax of a logic binding is any operator such as <and> [command] wherein the command can appear one or more times following by the operator such as </and>. The entire <and> block receives a true value if all the “commands” return a true value and empty group receives a false value. The operator <or > receives a true value if one (or more) of the elements are true. An empty group receives false. A <xor> operator expects exactly two elements, and receives a true value if and only if the exclusive- or value of them is true. The <not> operator can receive only one element, and returns the opposite logic value of it.

The operator <out_of number=“N”> receives true if and only if at least N of the commands are true. The operator <exact_out_of number=“N”> receives true if and only if exactly N of the commands are true. For both of these operators, the total number of commands must be larger or equal to N. If N is not defined, its default value is zero.

The operator [command] can be either a leaf (“use_macro”, an atom, and the like), another logic binding operator, or a “special command” as defined hereinafter.

The Atoms are the basic building blocks of the queries. Atoms represent basic fragments of information from the game. Atoms refer both to events (e.g. killing an opponent or a character or an animate object within the game) and to states (e.g. health or “number of lives”, for example, which reveal the relative status of the player's character and/or of other characters). The syntax of the Atom command is:

<atom_name>
<atom_tag1>value1</atom_tag1>

<atom_tag2>value2</atom_tag2>

<atom_name>

wherein <atom tag> can appear one or more times. For example:

<Kill>
<killer>_self</killer>
<victim><player>
<group>enemy</group>
<id>enemy1</id>
</player>
</victim>
<weapon>sniping</weapon>
</Kill>

Wherein <victim>, <weapon> and <killer> are all tags of the atom <Kill> and wherein _self and <player> are defined hereinafter.

The “use_macro” command is used for executing queries, which were saved either in the same file or in other files. The syntax of this command is:

<use_macro name=“NAME”,

parameters= “param_string”>

</use_macro>

Wherein param_string is a string, which may include one of more of the parameters to be used in the macro, and their values. For example:

<use_macro name=“BRAVE”,
parameters=“fighting_object=enemy1, weapon=knife”>
</use_macro>

which is used for returning the value of the use_macro command, for the purpose of calculating the value of its “parent”

The Clock command is used for the construction of temporal logic. The clock command can be applied anywhere within a block. Once activated, it generates a temporary entry in a build-in associative array inside the resolver. This entry can later be used by other commands as described in greater detail below. The clock's base point can only be the elements that are located under its own parent. The clock command can be used in order to mark times of and timing for other elements. The syntax of the clock command is:

<clock>

<id>clock_id</id>
<start>starting_point</start>
<type>starting_offset_type</type>
<value>starting_offset</value>

</clock>

The tag <id> defines the clock identifier, which is the name of the element in the resolver's clock associative array. The tag <start> defines the clock base position of the clock, relative to the collection of its “siblings” (the elements under the same parent). Values are “begin” (for referring the first time step of the first element that returns a “true” value), “end” (for referring the last time step of the last element which returns a “true” value), or “middle” (avg. of “begin” and “end”). The value of <type> can be either “absolute” or “percentages”, and <value> is a numeric value. <Type> and <value> define the exact time step which this clock marks.

The events described hereinafter, which are defined by a query that is called by a parent (upper level) query, preferably are not later used in the cinematic part of the parent query, unless provided as a parameter directly to the query when it is called. This rule also enables queries to be used separately from their logic value, and also for generating of movie fragments. All the cinematic commands of the query are preferably wrapped into a single movie, which can be used by defining this query as an event as explained hereinafter. The clocks, events and identifiers of the “called” query have to be provided by the calling query while calling the called query in order to be able to use clocks. For example, suppose a query Q1 defines a clock called clock attack, for defining timing for an event such as an attack, which the calling query wants to later access. The calling query preferably provides the following command to the called query: <use_macro name=“Q1” parameters=“clock_attack=clock1”>. Then, each time that “clock1” is called from outside Q1, it will equal clock_attack. However, the called query does not know that a clock by the name of clock1 exists.

If a clock, character or event id as defined by the sub-query is also defined by the query, then the definition that appears in the query preferably overrides the definition in the sub-query (ie the called query).

The For all tag is preferably used for defining a scenario in which a specific predicate must hold for all objects of specified type as opposed to the normal case, in which a single instantiation is sufficient.

The syntax is:

<for_all>
<object>...</object>
<name>...</name> <percentage>...</percentage>
<predicate>...</predicate>
</for_all>

The tag <object> defines a group of one or more objects; the tag <name> refers to the name of the character and percentage refers to the percentage of success of the action (for example if the action is “kill”, the percentage can be at least 50%, which means kill at least 50%) and the predicate describes the action to be performed.

The following example defines a scenario in which _self kills at least 50% of the total enemy players:

<for_all>

<object>

<player><group>enemy</group><\player>

</object>
<name>dead_enemy</name>
<percentage>0.5</percentage>
<predicate>

<Kill>

<killer>_self</killer>
<victim>dead_enemy</victim>

</Kill>

</predicate>

</for_all>

The Special commands function as a “leaf” for the purpose of constructing and calculating the logic expression tree, as they do not return any logic value. Instead, they invoke other required operations.

The Player command is used for binding identifiers and players in the game. The syntax is

<player>

<group>enemy</group>
<id>player_id</id>
<type>human</type>
<real_id>id</real_id>

</player>.

The proper value of the player can optionally be assigned in a symbolic way, using the value of id as defined in a separate location. As a result, the player tab does not necessarily define a specific player, but rather optionally defines a group of possible players, and adds a constraint to the system which is preferably maintained for this group. Players may then be added to or deleted from this group, according to whether the constraint is to be applied to them.

The Game state container is used for accessing the variety of containers stored and maintained by the resolver. For example, for requiring for the health of player player_id at time clock_id, the following query is used:

<Health>

<object>player_id</object>
<value>health_value</value_id>
<time>clock_id</time>

</Health>

The returned value health_value can be used in the next queries. The game state containers include but are not limited to the following containers: Health, Score, Deaths, Location, Weapon, Ammunition, Inventory, Exposure (which means exposure to controlling area or to other enemy players), Domination (Which means controlling “controlling” areas), RealNames (which is used for the cinematic engine) and Picture (which is used for the cinematic engine).

The Math tag enables the defining of a mathematical constraint. The syntax is <math>“expressions”</math>. For example

<math>“health_id_HT 20”</math>
All operators are represented by _Operator expression (_HT for >, _LTE for <=, etc’).

Boolean functions are used where necessary. For example, the tag <all_different> is used for stating that all the given IDs represent different entities. For example—

<all_different>

<object>_self</object>
<object>player1</object>
<object>player2</object>

</all_different>

The TAG <all_equal> has similar syntax as <all_different> and is used for stating that all the given IDs represent the same entity.

The tag Events is used for defining events to be used later in the cinematic section for marking the beginning and ending of scenes, as well as for marking the main characters of the movie. In order for those Events to be accessed by a “calling” query, they must first be constructed with “stubs” with empty values which are then filled by the calling query. The Syntax is:

<event>
<id>id</id>
<type>type_of_event </type>
<time>time </time>
[<active>
[<object>object</object>]
[<type>type_of_active</type>]
[<location>location</location>]
</active>]
[<active>...</active>]
...

</event>

In which the term “id” is the event's id, “type_of_event” is the type of event (for example, assault, knifing and the like), “time” is the time this marker refers to (a string expression, which may include both math and references to clocks, etc’), and wherein “type_of active” is the type of action being performed by the player such as swinging a sword for a specific action, or potentially a more general action (such as participating in a fight).

Location is an interesting geographic property, relevant to this event, and to this player. For example:

<event>
<id> main_fight_start</id>
<type>assault</type>
<time>“clock1-2”</time>
<active>
<object>_self</object>
<type>leading</type>
<location>

<x>204</x>
<y>100</y>
<z>−2</z>
<roll>0</roll>
<pitch>20</pitch>
<yaw>90</yaw>
<in_zone = “”></in_zone> % name of a specific zone, or a
polygon.

</location>
</active>
<active>
<object>enemy1</object>
<type>victim</type>
</active>

</event>

Wherein roll, pitch and yaw are provided in angles and zone is a name of a specific zone or a polygon.

It should be noted that “type_of_event” may receive any value, and that the active players are defined by using the <active> tag. Alternatively, for some pre-defined common events a “shortcut” which can be used. For example:

<event>
<id> first_kill</id>
<type>Kill</type>
<time>“clock1-2”</time>
<killer>_self</killer>
<victim><enemy1</victim>

</event>

The event is activated only if its parent (upper level) receives a true value meaning that the operator which includes the event is satisfied.

The <score> command is used for applying changes to the overall score of the query. Like the logic parts of the query, it is also calculated using the tree structure. The <score> command, like the <event> command, can be placed anywhere within a block. The command can appear more than once in the same block. The <score> command, like the <event> command, is activated meaning that the changes the command requests to apply on the overall score take place only if the block containing it was satisfied. A nested (or even recursive) use of the <score> command is preferable.

### The Syntax is:

<score>

<operator>operator_type</operator>
<value category>change_value</value>
<id>object</id>
<category>category</category>

</score>

The term “operator_type” is the type of change, which has to be applied on the overall score. Values include but not limited to {add,sub,mukdiv,power]. The term “change_value” is the numerical value to be used. Use of the <math> command inside the <value> command is an option.
The term “object” is the object to which the scoring should be applied. Default is _self.
The term category is a category for which this scoring rule should be applied. When no value appears, the default (which can be called by _generic) is used.

<score>
<operator>add</operator>
<value><math>“1+1/Health(_self,_clock)”</math></value>
<Health>″
</score>

The term clock indicates the current time is equal to starting time of block.

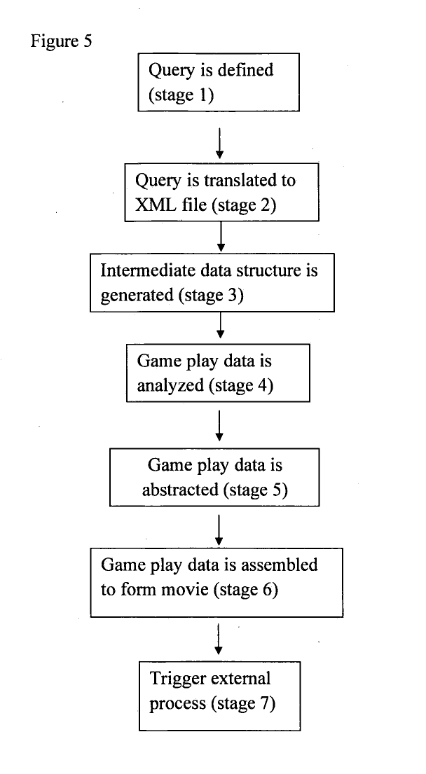

In stage 3, at least one and preferably a plurality of queries are executed. In stage 4, at least one type of information from the gaming system is exported from the gaming system on the basis of the executed query or queries. According to one embodiment of the present invention, the system and method can be used for creating movies, as a non-limiting example of export of information from the gaming system. Cinematic directives are used for the creation of movies based on this query (as shown in FIG. 4 by cinematic directives 410). Cinematic directives are defined only once and may be defined with no parameters in the cases when the query is used only for scoring, or for purposing of scouting and the generation of second order information such as the best place to set an ambush. FIG. 5 describes how the movie itself is created in more details.

The Syntax is

<cinema>

[segment1]
[segment2]
...

</cinema>

wherein the “cinema” section is a collection of elements of type “segment”.

A Segment is the basic element of the cinema section. The result of a single segment is a single movie. The movies, which are derived from the various segments, are concatenated to the final movie of the cinema section. The order of the segments is determined by the <order> command (see below). The basic structure of the segment is similar to the body of the query, which is a tree of cinematic segments.

The syntax is:

<segment>

<order>order</order>
[<segment>...</segment>]
[<segment>...</segment>]
[<segment>...</segment>]
[<segment>...</segment>]
....
[<condition>[condition]</condition>]
[<condition>[condition]</condition>]
[<condition>[condition]</condition>]
...
[<random>[segment / cinema_leaf] [segment /
cinema_leaf]...</random>]
[<random>[segment / cinema_leaf] [segment /
cinema_leaf]...</random>]
[<random>[segment / cinema_leaf] [segment /
cinema_leaf]...</random>]
...
[cinema_leaf]
[cinema_leaf]
[cinema_leaf]
...

</segment>

The term “order” is the internal ordering of this segment, compared to the other segments, which appear in its level under the same parent (hierarchy). If two or more segments have the same order value, then the resolver may sort them arbitrarily. The <condition> command is used for conditioning the inclusion of a segment as described hereinafter. The term <random> is used for creating a non-deterministic template as described hereinafter. The term “cinema_leaf” represents basic cinematic commands as described hereinafter.

The tag <condition> is used for conditioning the inclusion of a segment surrounding the condition tag. The syntax is:

<condition>

[logic_expression]

</condition>.

The term “logic_expression” is a logic expression, similarly to the ones used in the <body> section. A plurality of “conditions” may appear. In this case, the resolver assumes that these conditions are connected using an “and” logic operator. When no “condition” appears, the segment is always included.
For example:

<segment>

<add_effect>“......”</add_effect>
<condition><flag>USE_INTENSIVE_VIDEO_EFFECTS</flag></conditi

on>

<condition>
<and>
<defined>enemy1</defined>
<defined>main_fight_start</defined>
<math>“main_fight_end − main_fight_start > 20”</math>
</and>

</condition>

<add_effect>“......”</add_effect>

</segment>

The tag <random> is used for directing the resolver to arbitrarily select one out of several possible segments.

The syntax is

<random>
[segment1 / cinema_leaf1]
[segment2 / cinema_leaf2]
...
</random>

The tag <cinema_leaf> is the basic building block of the cinematic section. Like segments, leaves can optionally comprise an <order> command. If not, they are sorted arbitrarily by the resolver.

The <add_effect> tag is the basic cinematic directive for pre-rendered content.

The syntax is <add_effect>” . . . “</add_effect>

The <add_video> is a shortcut for adding a pre-rendered video file. The shortcut be implemented using the <add_effect> command.

The syntax is:

<add_video>
<name>filename.extension</name>
<alpha>alpha_value</alpha>
<start>start_time</start>
<duration>duration</duration>
<voice_volume>volume</voice_volume>
<overlay>

<position>

| | |
|---|---|
| <x>x</x> | % 0 to inf (default is 0) |
| <y>y</y> | % 0 to inf (default is 0) |

</position>
<scale_x>s_x</scale_x>% 0 to inf (default is 1)
<scale_y>s_y</scale_y>% 0 to inf (default is 1)

</overlay>
<parameters>more_parameters</parameters>

</add_video>

The term “filename.extension” is the video file to be added. The term “alpha_value” is the alpha blending parameter. If several video files are displayed at the same time, the files are layered by the resolver according to their initialization times such that latest video files appear “above” previous layers. The term “start_time” is the starting point within the movie. The term “duration” is the maximal duration of the video (stopped if movie is longer). The term “volume” is the volume of the movie. The term “overlay” means that this visual data should be added on top of the previous segment (using the specified parameters). If this tag does not appear, the default of video concatenation is used. The term “more_parameters” is a string containing additional parameters for the resolver.

The <add_picture> is a shortcut for adding a pre-rendered picture file. The <add_picture> can optionally be implemented using the <add_effect> command The Syntax is:

<add_picture>
<name>filename.extension</name>
<alpha>alpha_value</alpha>
<start>start_time</start>
<duration>duration</duration>
<position>
<x>x</x> % default is 0 (from 0 to inf)
<y>y</y> % default is 0 (from 0 to inf)
<scale_x>s_x</scale_x> % default is 1 (from 0 to inf)
<scale_y>s_y</scale_y> % default is 1 (from 0 to inf)

</position>

<overlay>[void]</overlay>
<parameters>more_parameters</parameters>

</add_video>

The term “filename.extension” is the picture file to be added. The term “alpha_value” is the alpha blending parameter. The term “start_time” is the starting point within the current block starting at which the picture is presented. If “start_time” doesn't appear, is assumed to be zero. If “start_time” exceeded the current block time, it is ignored. The term “duration” is the duration for which the picture should be displayed. If duration does not appear, the picture is presented until the end of this block. If duration exceeds the total time of the block, then the duration is truncated at the end of the display time of the block. The term “position” is the position and size of the display. The term “overlay” relates to the data that is added on top of the previous segment's value (using the specified parameters). If this tag does not appear, the default of picture concatenation is used. The term “more_parameters” is a string containing additional parameters for the resolver. The term <add_voice> is a shortcut for adding a pre-rendered voice file (as a non-limiting example of an audio file). The shortcut can optionally be implemented using the <add_effect> command. The Syntax is:

<add_voice>
<name>filename.extension</name>
<mute_underlay>boolean</mute_underlay>
<start>start_time</start>
<duration>duration</duration>
<volume>volume</volume>
<parameters>more_parameters</parameters>

</add_voice>

The term “filename.extension” is the voice file to be added. The term “mute_underlay” determines whether other voice channels in the same time steps are muted. If several voice channels have a true value for this parameter and are taking place at the same time, the channel which starts at the latest time step takes total control of the channel. The term “start_time” is the starting point within the voice file. The term “duration” is the maximal duration of the voice (stopped if voice file is longer). The term “volume” is the volume of the voice. The term “more_parameters” is a string containing additional parameters for the resolver.

The tag <camera> is the basic cinematic directive for querying generated content. The Syntax is:

<camera>

<type>type</type>

<point_of_view>object</point_of_view>
<start>starting_time</start>
<stop>stop_time</stop>

</camera>

The term “type” is the type of camera to be used. The term “point_of_view” is the object this camera refers to. The term “starting_time” and “end_time” define the time within the current block that has to be captured.
For example:

<camera>

<type>first_person</type>

<point_of_view>_self</point_of_view>
<start><math>“main_fight_end − 20”</math></start>
<stop>main_fight_end</stop>

</camera>

When the value of “type” is complex, the system expects to receive additional information, of the following type:

<complex>

<position>

<x></x>

<y></y>
<z></z>
<roll></roll>
<pitch></pitch>
<yaw></yaw>
<zoom></zoom>
<type>

<position>
<reference>reference</reference>
<effect>...</effect>
<effect>...</effect>
<effect>...</effect>
<effect>...</effect>
<smooth>...</smooth>

</complex>

The term “position” is the position plus orientation of the camera. The term “reference” states whether the position is calculated using the (0,0,0,0,0,0,0) as its reference point (default) or some other point (including a moving point, such as a player). The “effect” can be any kind of the supported effects which are preferably one or more of:

<zoom parameters=“...”></zoom>
<matrix parameters=“...”></matrix>
<pan parameters=“...”></pane>
<tilt parameters=“...”></tilt>
<generic parameters=“...”></generic>

The term smooth indicates that the camera transits from the last position of the camera to the beginning point of this camera in a smooth motion. If this is not included, then the (default) “shot jump” option is used instead. Options for the smooth are, for example

<time>transition_time</time>
<type>type_of_smoothing</type>
<walls>avoid / move_along / move_through</walls>
<extra>extra_time</extra>.

The term Extra_time states how much of the transition time may be added to the movie as “extra” footage. The rest of the transition time will have to be integrated into the camera event time.
Below is an example of a complete cinema set of cinematic directives, which as currently described defines a single movie. However optionally a complete set of such directives can define more than one movie.

% In this example, we can use “ main_fight_start”, “main_fight_end”, as well as
variousclocks.
% In addition, effects from our current (and future) effects library can be used.
% Basic component here is “segment”. Concatenation of them gives the final movie.
% Structure of movie is given in a tree like description. Nodes of each junction are
numbered.
% In each segment there can be only one “camera” part, but many “add_effect” parts.

<cinema>

<segment>

<order>1</order>
<random>

<camera>....</camera>
<camera>....</camera>
<camera>....</camera>

</random>

| </segment> | |
|---|---|
| <segment> | % Example of nesting |

<order>2</order>
<segment>

| | |
|---|---|
| <order>2</order> | % Internal ordering |

<camera>
.....
</camera>
<add_effect>“......”</add_effect> % Michael's language
<add_effect>“......”</add_effect>
<segment>

<condition>

<flag>USE_INTENSIVE_VIDEO_EFFECT

S</flag>
</condition>
<add_effect>“......”</add_effect>

</segment>

</segment>
<segment>

<order>1</order>
<add_video>

<name>intro.flv</name>
<parameters>“mute”</parameters>

</add_video>
% A shortcut for pre-rendered movies.
% “Canonic” way is by “Add effect”.

</segment>
<segment>

| <order>3</order> | |
|---|---|
| <add_picture>....</add_picture> | % This is a shortcut. |

“Correct” way is by
% “Add effect”
% Various properties
can be added
% (duration, voice
over, alpha, ...).

</segment>

</segment>
<segment>

<camera>

<type>first_person</type>
<point_of_view>_self</point_of_view>
<start><math>“main_fight_end − 20”</math></start>
<stop>main_fight_end</stop>

</camera>
<condition>

| | |
|---|---|
| <and> | % Conditional |

<defined>enemy1</defined>
<defined>main_fight_start</defined>
<math>“main_fight_end − main_fight_start >

20”</math>
</and>

</condition>
<order>3</order>

</segment>

</cinema>

</query>
</MQL>

FIG. 5 is a flowchart of an exemplary method for translating the query directives into a movie, through the capture of the desired data from actual game play in this non-limiting example. In stage 1, the query is defined as previously described, through the use of the visual language. In stage 2, the query is translated to the above described XML file by a generator. In stage 3, an intermediate data structure is preferably generated. This stage is preferably performed by the resolver (described above), which receives the above described XML file and translates it to a query that can optionally be used dynamically during the game play to detect and abstract the desired data. The resolver also preferably resolves the query as described herein.

In stage 4, game play data is analyzed according to the above query, by the analyzer (the resolver is also optionally contained within the analyzer). Optionally, the intermediate data structure is stored, although alternatively it may not be stored. Additionally or alternatively, temporarily or dynamically calculated or determined information may also optionally be stored (for example, information obtained through the resolution of a previous query or subquery).

Also optionally, the query comprises a plurality of rules which are then interpreted by a rule engine. For this embodiment, optionally the query does not need to be converted to any type of intermediate data structure; instead, the rule engine interprets the provided rule(s) of the query to determine how to execute the query for analyzing game play data.

In stage 5, game play data is abstracted, including visual sequences and optionally including one or more of a still picture and/or audio data and/or other data, whether concatenated or overlaid as described above. In stage 6, the game play data is assembled to a movie, optionally with the one or more other types of data as described above. Such assembly is preferably performed with a video template file, which directs how the various components are to be combined. Once selected and provided as described above in stages 1-6 and also optionally from other aspects of the above description, the technical combination of two or more movie components, such as for example adding a “voice over” to the movie, may optionally be performed as is known in the art.

Optionally in stage 7, the query triggers an external process. This external process may optionally be triggered earlier, for example before or after any of stages 4-6, or simultaneously. The external process may optionally take action based on any type of analysis, for example statistical analysis, or fraud detection (for example, for cheating game players). The action may also optionally alert a player in real time and/or to indicate that a particular player is performing highly successfully (above a certain threshold). The external process may also optionally activate a process or action on the computer of the game player. The external process may also optionally relate to injection of content to the displayed game play data, even during game play. Also the external process may optionally be triggered for other types of complex data and not only game play data.

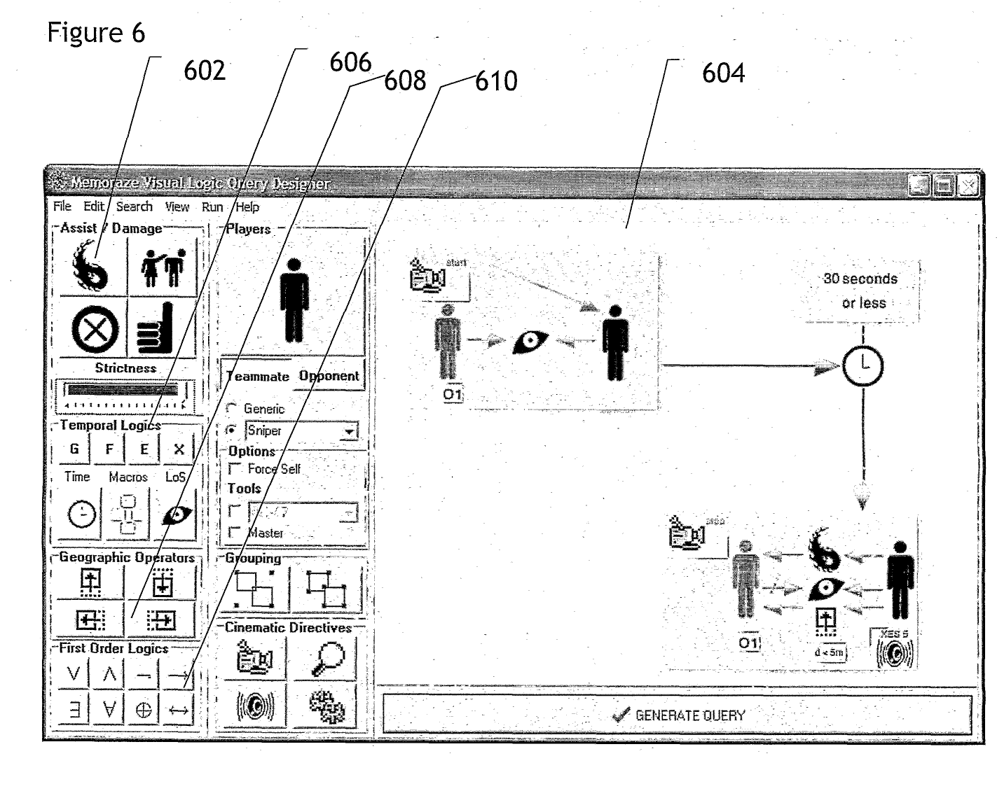

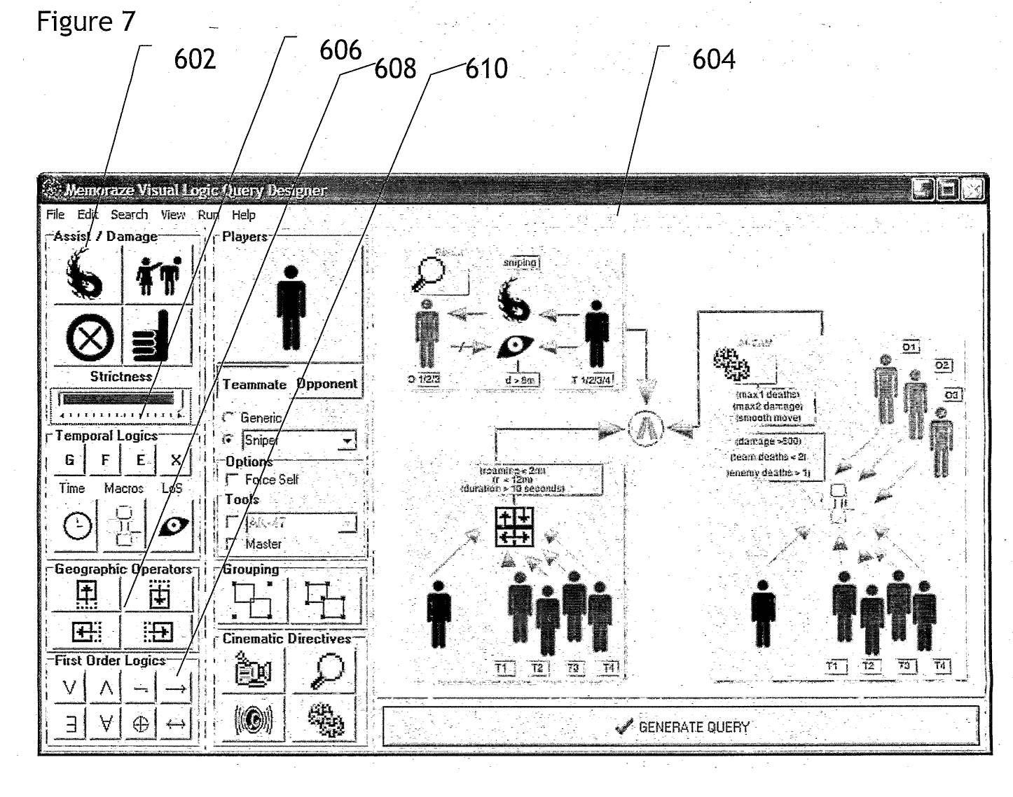

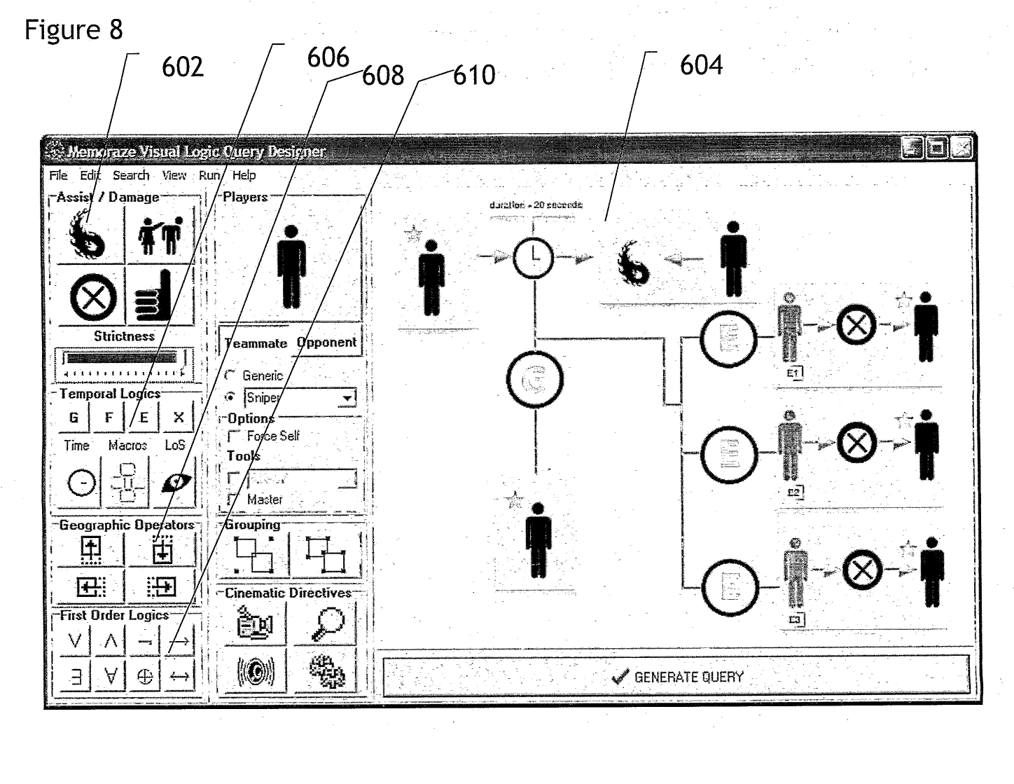

FIGS. 6-8 relate to exemplary, non-limiting screenshots of the visual scripting tool. Overall the scripting tool preferably features the following components: a stencil panel; a designer area; cinema toolbar and other toolbars; logic relation panels. These items are described in greater detail below with regard to the non-limiting examples shown in the relevant Figures.

A non-limiting example of the stencil panel with regard to the illustrative user interface of FIGS. 6-8 is shown as an interface stencil panel 602. The item stencil panel holds all available items for creating the diagram. The arrangement of the items in the stencil panels, including with regard to providing multiple such stencil panels, is preferably configurable. The user can drag an item from the stencil panel 602 and place it in the designer area 604 (shown as a non-limiting example only).

Additional effects are preferably added through the use of one or more toolbars, such as for example a cinema toolbar (not shown). The cinema toolbar may optionally be used to add one or more of an object; a special effect (whether generic or predefined); an event object; or a random object; and/or managing event categories. Camera and effects objects can be linked to queries or sub-queries themselves, or may be placed on their own, linked, grouped etc, and later be linked to the main query. This will be translated to the language for defining cinematic events and scenes. When cinema and effects objects are groups, a “random” object can be added to this group.

Other toolbars may optionally be used for adding audio effects or for connectors between items (not shown).

Other panels, such as for logical relations, include but not limited to a temporal logic panel 606; a geographic operator panel 608; and a first order logic panel 610. These panels operate to support query construction as previously described.

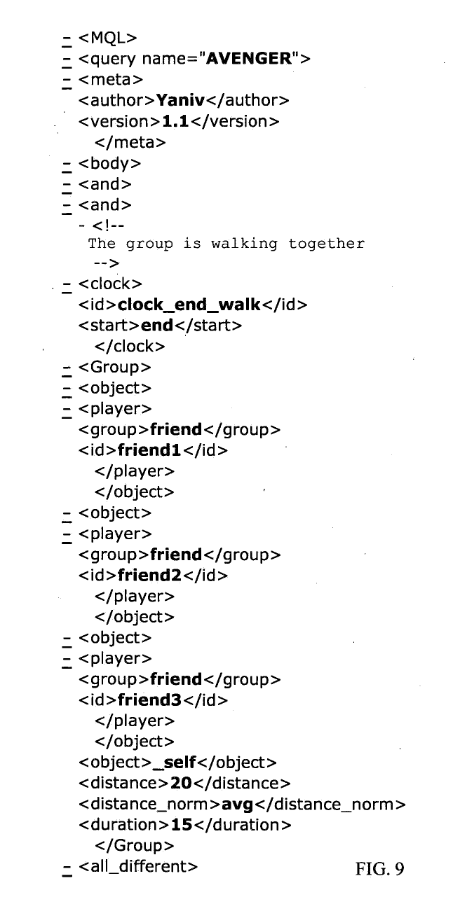

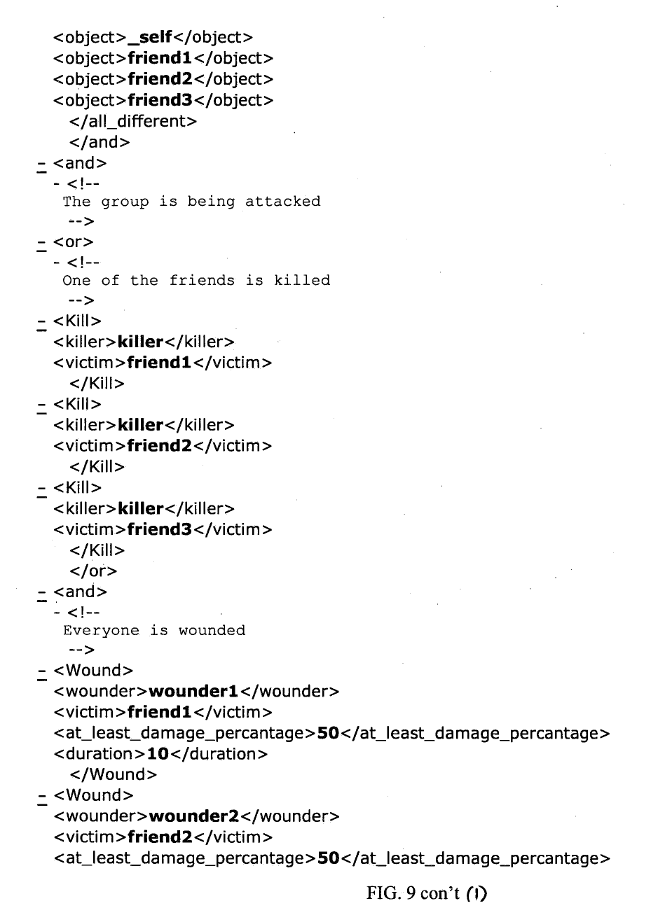

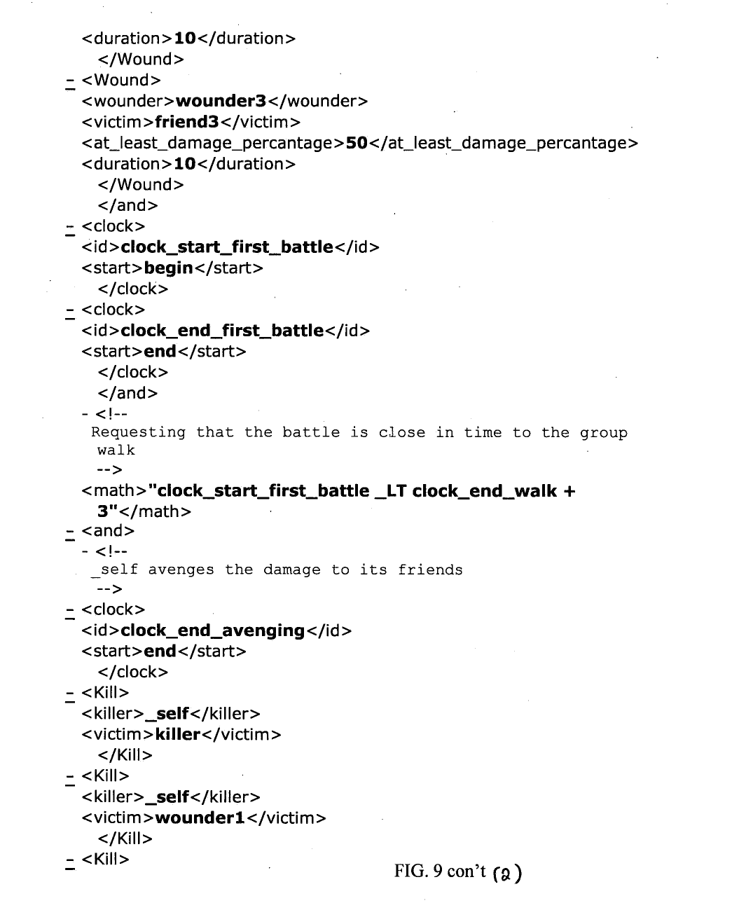

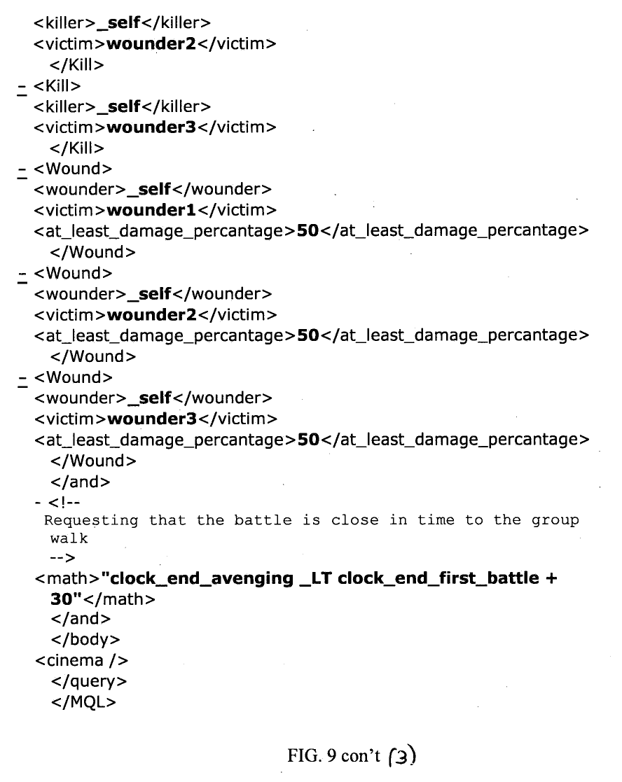

FIG. 9 shows an exemplary complete script for executing a query to create a movie according to the following situation, for “The Avenger”. In this game scenario, four players are walking together (one of them is _self). Suddenly, all 3 of the other players, apart from _self, sustain heavy damage (more than 50% of the Health they had), and at least one of them is killed. This is done in a short period of time. After at most 30 seconds, _self_kills all the attackers of his or her friends, while being also the major cause of the damage being caused to them (namely, not only the final blows).

Although embodiments of the invention have been described by way of illustration, it will be understood that the invention may be carried out with many variations, modifications, and adaptations, without departing from its spirit or exceeding the scope of the claims.

1. A method for detecting a component from a complex set of data, performed by a computer, wherein the complex set of data comprises game play data, wherein said game play data is from a game in which at least a portion of the game play and/or at least one game action occurs electronically, through a computer or any type of game playing device, the method comprising providing a plurality of components; selecting at least one component through a visual language for identification of said at least one component for detection in the data by a human operator of the computer; automatically executing at least one command according to said visual language by the computer; and detecting said selected component in said complex set of data according to said at least one executed command by the computer, wherein the complex set of data relates to human behavior and/or human controlled or manipulated objects; wherein the computer comprises a network of a plurality of computers, and wherein at least one computer is operated by said human operator for selecting said at least one component and wherein said automatically executing said at least one command is performed by at least one other computer in said network of computers.

2. (canceled)

3. The method of claim 1, further comprising displaying said at least one selected component to a human operator through a display device.

4. The method of claim 1, wherein said selecting said at least one component further comprises selecting a plurality of components for detection; and determining an interaction between the plurality of components through said visual language; wherein said visual language is provided to said human operator through a GUI (graphical user interface) on the computer.

5. (canceled)

6. (canceled)

7. (canceled)

8. The method of claim 1, wherein said game is selected from the group consisting of portable games, computer games, on-line games, multi-player on-line games, persistent on-line or other computer games, games featuring short matches, single player games, automatic player games or games featuring at least one “bot” as a player, anonymous matches, simulation software which involves a visual display, monitoring and control systems that involve a visual display, arcade machines, video games, console games, software related to the operation of casinos or games and chance.

9. (canceled)

10. (canceled)

11. (canceled)

12. The method of claim 1, wherein the complex set of data comprises audio data.

13. (canceled)

14. The method of claim 1 wherein said visual language is used to construct a query for detecting said selected data from a complex set of data.

15. The method of claim 14, wherein said query is interpreted into a GGRL language.

16. The method of claim 15, wherein said query comprises a plurality of rules and wherein said executing said at least one command according to said visual language further comprises interpreting said rules of said query by a rule engine for analyzing the data.

17. The method of claim 1, wherein said selecting further comprises constructing a query according to said visual language by said human operator; translating said query to a script language or to an interpretable language; and converting said script language or said interpretable language to an intermediate structure.

18. A system for detecting a component from a complex set of data; comprising:
a. A computer for selecting at least one component through a visual language for detection in the data, said computer providing a GUI (graphical user interface) to a human operator for constructing a query according to said visual language; and
b. A server in communication with said computer for analyzing the complex set of data according to said visual language query and for storing said at least one selected component.

19. The system of claim 18, further comprising a data base for storing said at least one selected component.

20. The system of claim 18 wherein said computer and said server communicate via the internet network.

21. A method for generating at least one scene in a film comprising: providing a plurality of components; automatically selecting at least two components through a visual language from a complex set of data, and composing at least one scene from at least two components, wherein the complex set of data relates to human behavior and/or human controlled or manipulated objects.

22. The method of claim 21, wherein said selecting said at least two components further comprises determining an interaction between at least two components through said visual language.

23. The method of claim 22, wherein said visual language is provided to a user through a GUI (graphical user interface).

24. The method of claim 23, wherein said GUI comprises a stencil panel for selecting one or more objects, a logic connector panel for connecting said one or more objects and a designer panel for viewing said one or more objects with one or more connections.

25. The method of claim 22, wherein said selecting of data is automatically translated into a query language.

26. The method of claim 25 wherein said query language is used for constructing one or more scenes in a film.

27. The method of claim 26, wherein said composing at least one scene comprises receiving selected components, selected according to said query language; and combining said selected components according to a video template.

28. The method of claim 27, wherein said query language includes one or more cinematic directions for combining said selected components.
